(19) United States
(12) Patent Application Publication
(10) Pub. No.: US 2025/0099928 A1
(43) Pub. Date: Mar. 27, 2025

(54) DISPERSER AND METHOD FOR USING SAME

(71) Applicant: M. TECHNIQUE CO., LTD., Izumi-shi, Osaka (JP)

(72) Inventor: Masakazu ENOMURA, Izumi-shi (JP)

(73) Assignee: M. TECHNIQUE CO., LTD., Izumi-shi, Osaka (JP)

(21) Appl. No.: 18/291,416

(22) PCT Filed: Jun. 13, 2022
(86) PCT No.: PCT/JP2022/023569

§ 371 Date: Jan. 23, 2024

(51) Int. Cl. B01F 25/442; B01F 35/512; B01F 35/92

(52) U.S. Cl. CPC B01F 25/4422; B01F 35/512; B01F 35/92

(57) ABSTRACT

A disperser includes an outer member and an inner member located radially inside the outer member. A flow path is formed between the outer member and the inner member, through which fluid flows from one side to the other side in the axial direction. The flow path includes a first region that extends spirally from the one side to the other side and a second region that extends continuously from the first region to the other side. The second region is defined by the tapered inner circumferential surface of the outer member and the tapered outer circumferential surface of the inner member. The tapered inner circumferential surface and the tapered outer circumferential surface are formed such that the angle of one with respect to the other in the axial cross section changes in the middle of the second region, and the second region of the flow path has portions each having a different clearance distance.

### TECHNICAL FIELD

The present disclosure relates to a disperser capable of producing nanoparticles by low-power dispersing. Specifically, the present disclosure relates to a high-performance disperser capable of nano-level dissolution and macromolecular dissolution as well as nanoparticle production, which can also be used for crystallization and emulsion polymerization, and a method for using the same.

### BACKGROUND ART

In the pharmaceutical and chemical industries, nanoparticles have entered the stage of practical use. For example, vaccines against novel coronavirus infection (COVID-19) are known worldwide. RNA vaccines are the first COVID-19 vaccines to be authorized in the United States and the European Union. The RNA vaccine contains ribonucleic acid (RNA), and when introduced into human tissue, messenger RNA (mRNA) induces cells to produce foreign proteins and stimulates an adaptive immune response, teaching the body how to identify and destroy the corresponding pathogen. Although not always the case, RNA vaccines often use nucleotide-modified mRNA. The delivery of mRNA is achieved by a co-formulation of the molecule into lipid nanoparticles, which protect the RNA strands and help their absorption into the cells. The particle size is said to be 100 nm. In addition, other types of vaccines such as virus-like particle vaccines and DNA plasmid vaccines are in clinical trials, and many nanospheres, liposomes, nanoemulsions, and the like are being developed. Therefore, there is a need for a disperser that produces ultrafine particles with controlled shear force, especially one that can produce fine particles for injection.

Patent Document 1 discloses a high-performance stirring disperser. In the disperser, blades rotate at high speed in a tank, and a screen with slits rotates at high speed in the opposite direction to the blades, creating a jet stream that provides a shear force to atomize a fluid into fine particles. The problem with the disperser is that it requires a lot of power.

Patent Document 2 discloses a manufacturing method for producing lipid emulsions and liposomes in a short time and with low power. In this manufacturing method, a phospholipid-containing material to be treated is pressurized and subjected to high-speed rotation to atomize it into fine particles. At this time, air spaces are eliminated because if they are present in the dispersion tank, many small air bubbles are mixed into the material to be treated, creating a pseudo-compressible fluid and making it difficult to properly apply a shear force. The manufacturing method also requires a considerable amount of power.

Patent Document 3 discloses a flow reactor (continuous reactor) that has a high heat exchange rate and can be disassembled. Although excellent as a flow reactor, it has too little shear force to be used as a disperser, and it is difficult for the reactor to produce nanoparticles for the above-mentioned vaccines or the like.

Patent Document 4 discloses a gap shear disperser that includes a conical rotor and a conical vessel with a sloped inner wall that concentrically houses the rotor. The shear disperser is designed for uniform atomization of viscous materials such as pastes. Considering the structure and the center runout caused by the rotation of the rotor, it is difficult to make the gap between the rotor and the vessel in microns. Even if the gap between the rotor and the vessel is made in microns, due to the hollowing phenomenon that occurs in the gap when a viscous fluid is treated, it is difficult to apply a shear force to the material being treated.

### PRIOR ART DOCUMENT

### Patent Document

Patent Document 1: Japanese Unexamined Patent Application Publication No. H04-114724
Patent Document 2: Japanese Unexamined Patent Application Publication No. H09-24269
Patent Document 3: Japanese Unexamined Patent Application Publication No. 2021-105507
Patent Document 4: Japanese Unexamined Utility Model Application Publication No. H03-79834

### SUMMARY OF THE INVENTION

### Problems to be Solved by the Invention

In view of the foregoing, it is an object of the present disclosure to provide a disperser capable of producing fine particles, especially nanoparticles, by efficiently applying a shear force to a material to be treated with low power, and a method for using the same.

### Means for Solving the Problems

To achieve the object mentioned above, according to the first aspect of the invention, a disperser includes: a cylindrical outer member having a tapered inner circumferential surface in a portion thereof; and an inner member located radially inside the outer member and having a tapered outer circumferential surface in a portion thereof. The tapered outer circumferential surface faces the tapered inner circumferential surface of the outer member. A flow path is formed between the outer member and the inner member, through which fluid flows from one side to the other side in the axial direction. The flow path includes a first region that extends spirally from the one side to the other side and a second region that extends continuously from the first region to the other side. The second region of the flow path is defined by the tapered inner circumferential surface and the tapered outer circumferential surface. The tapered inner circumferential surface and the tapered outer circumferential surface are formed such that the angle of one with respect to the other (the angle therebetween) in the axial cross section changes in the middle of the second region, and the second region of the flow path has portions each having a different clearance distance between the tapered inner circumferential surface and the tapered outer circumferential surface.

According to the second aspect of the invention, in the disperser of the first aspect, the outer member has a female-threaded inner circumferential surface located on the one side of the tapered inner circumferential surface. The inner member has a male-threaded outer circumferential surface located on the one side of the tapered outer circumferential surface and corresponding to the female-threaded inner circumferential surface, and is threadedly assembled to the outer member. The first region of the flow path is defined by the female-threaded inner circumferential surface and the male-threaded outer circumferential surface. The area of the first region of the flow path is defined by the shapes of the female-threaded inner circumferential surface and the male-threaded outer circumferential surface.

According to the third aspect of the invention, in the disperser of the first or second aspect, the second region of the flow path includes: a reduction region where the clearance distance decreases from the one side to the other side, and a constant region extending continuously from the reduction region to the other side, where the clearance distance is constant.

According to the fourth aspect of the invention, in the disperser of the third aspect, the constant region of the second region of the flow path has a length of 1 mm or more from the one side to the other side along the flow path direction in the axial cross section.

According to the fifth aspect of the invention, in the disperser of the second aspect, the female-threaded inner circumferential surface and the male-threaded outer circumferential surface have different shapes due to different thread angles.

According to the sixth aspect of the invention, in the disperser of the third aspect, in the constant region of the second region of the flow path, the clearance distance is 0.1 μm or more and 2 mm or less.

According to the seventh aspect of the invention, in the disperser of the third aspect, regions of the tapered inner circumferential surface and the tapered outer circumferential surface that define the constant region of the second region of the flow path are made of ceramic.

According to the eighth aspect of the invention, in the disperser of the second aspect, the outer member and the inner member can be rotated relative to each other to selectively place the disperser in any one of the following states without disassembling the outer member and the inner member: a contact state in which the tapered inner circumferential surface and the tapered outer circumferential surface are in contact with each other, a use state in which the disperser is used and the clearance distance is small, and a separate state in which the clearance distance is larger than in the use state.

According to the ninth aspect of the invention, in the disperser of the first or second aspect, the inner circumferential surface of the outer member and the outer circumferential surface of the inner member that define the flow path have no horizontal portion where the fluid flowing through the flow path may accumulate.

According to the tenth aspect of the invention, in the disperser of the first or second aspect, the inner circumferential surface of the outer member and the outer circumferential surface of the inner member that define the flow path are covered with a coating made of a corrosion-resistant material.

According to the eleventh aspect of the invention, in the disperser of the tenth aspect, the coating is a fluoropolymer coating.

According to the twelfth aspect of the invention, in the disperser of the first or second aspect, at least one of the outer member and the inner member has a jacket through which another fluid can flow to adjust the temperature of the fluid flowing through the flow path.

According to the thirteenth aspect of the invention, a method for using the disperser of the eighth aspect includes adjusting the clearance distance. The adjusting includes: rotating the outer member and the inner member relative to each other such that the inner member moves toward the other side with respect to the outer member to bring the disperser into the contact state; and thereafter rotating the outer member and the inner member relative to each other such that the inner member moves toward the one side with respect to the outer member to bring the disperser into the use state.

According to the fourteenth aspect of the invention, in the method of the thirteenth aspect for using the disperser of the eighth aspect, the disperser is placed in the separate state where the outer member and the inner member are separated during cleaning or sterilization of the flow path.

### Effects of the Invention

According to the present disclosure, shear force can be efficiently applied to a material to be treated with low power to produce fine particles, especially nanoparticles.

### BRIEF DESCRIPTION OF THE DRAWINGS

FIG. 1 is an axial cross-sectional view of a disperser according to an embodiment of the present invention.

FIG. 2 is an enlarged view of the main parts of the disperser illustrated in FIG. 1.

FIGS. 3A to 3C are diagrams for explaining the states of the disperser: FIG. 3A illustrates a contact state, FIG. 3B illustrates a use state, and FIG. 3C illustrates a separate state.

FIG. 4 is an enlarged view illustrating a modification of a second region of a flow path and corresponds to FIG. 2.

FIGS. 5A and 5B are diagrams for explaining a modification of the top portion of an inner member: FIG. 5A illustrates a state as viewed from above in the axial direction, and FIG. 5B illustrates an axial cross section.

FIG. 6 is a diagram for explaining the area of a first region of the flow path.

FIG. 7 is a diagram illustrating the disperser to which a precision positioning device is connected.

FIG. 8 is an axial sectional view illustrating a modification of the disperser.

FIG. 9 is an enlarged view of the main parts of the disperser illustrated in FIG. 8.

### MODES FOR CARRYING OUT THE INVENTION

Hereinafter, exemplary embodiments of the present invention will be described with reference to the accompanying drawings. In the drawings, the arrow “UP” indicates upward, and the line “CL” indicates the central axis of an outer member and an inner member. In the following description, the axial direction refers to a direction along the central axis CL of the outer member and the inner member, while the radial direction refers to a direction perpendicular to the central axis CL. In addition, the white arrow in the drawings indicates the direction of the flow of fluid to be treated. In the following description, one side in the axial direction is referred to as the lower side, and the other side in the axial direction is referred to as the upper side.

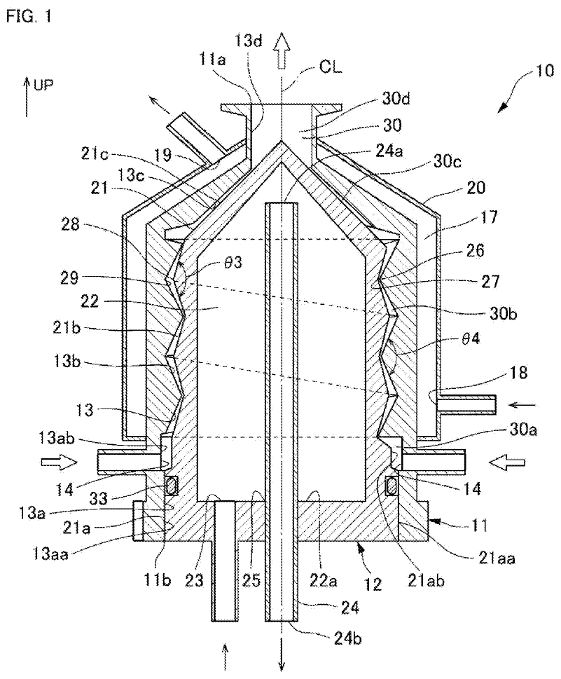

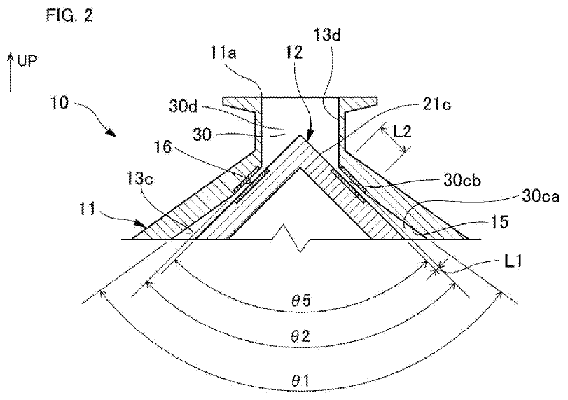

FIG. 1 is an axial cross-sectional view of a disperser 10 according to an embodiment of the present invention. FIG. 2 is an enlarged view of the main parts of the disperser 10 illustrated in FIG. 1.

As illustrated in FIG. 1, the disperser 10 of the embodiment is a device that can produce nanoparticles from a fluid as a material to be treated (hereinafter referred to as “fluid to be treated” or simply “fluid”) by pre-dispersing the fluid and then continuously and finely dispersing it. Note that “disperser” is a general term for equipment used to apply a shear force to a fluid to be treated to obtain a treated product. The disperser may be used not only for the production of fine particles such as nanoparticles, but also for the production of emulsions, liposomes, nanospheres, and the like, as well as for polymer dissolution, complete mixing at the molecular level, crystallization, and emulsion polymerization. In addition, the term “fluid” refers not only to gases and liquids, but also to powders, granules, slurries, and other fluid materials.

The disperser 10 includes an outer member 11 formed in a cylindrical shape extending in a predetermined axial direction (the vertical direction in this embodiment) and an inner member 12 that extends in the axial direction and is located radially inside the outer member 11. In this embodiment, the outer member 11 and the inner member 12 are concentrically arranged and assembled together so that their central axes CL coincide. There is a gap (space) between the outer member 11 and the inner member 12, and the gap serves as a flow path 30 through which a fluid to be treated flows. Unless otherwise specified, the following describes the structure of the disperser 10 in a state where it can be used as a disperser (hereinafter referred to as “use state”).

The outer member 11 has an upper end opening 11a at the upper end, a lower end opening 11b at the lower end, and an inner circumferential surface 13 extending between the upper end opening 11a and the lower end opening 11b. The upper end opening 11a and the lower end opening 11b are arranged to be concentric with the central axis CL of a space defined by the inner circumferential surface 13 (hereinafter referred to as “internal space”). In this embodiment, the upper end opening 11a is formed to have a smaller diameter than the lower end opening 11b. The lower end opening 11b of the outer member 11 serves as an insertion port for inserting the inner member 12 into the outer member 11.

The inner circumferential surface 13 of the outer member 11 defines the internal space of the outer member 11 and includes four regions, one on top of another, each having a surface of a different shape. In other words, the inner circumferential surface 13 of the outer member 11 includes four differently shaped surfaces: a lower-end inner circumferential surface 13a, a female-threaded inner circumferential surface 13b, a tapered inner circumferential surface 13c, and an upper-end inner circumferential surface 13d, in this order from bottom to top. That is, the outer member 11 has the tapered inner circumferential surface 13c in a portion thereof. The inner circumferential surface 13 of the outer member 11 defines the radially outer side of the flow path 30 (described later).

The lower-end inner circumferential surface 13a of the outer member 11 is located below the female-threaded inner circumferential surface 13b and extends continuously from the lower end opening 11b of the outer member 11 to the lower end of the female-threaded inner circumferential surface 13b. In this embodiment, the lower-end inner circumferential surface 13a is formed to have a larger diameter than the upper-end inner circumferential surface 13d. The lower-end inner circumferential surface 13a includes a lower portion 13aa that is in close proximity to or in contact with an outer circumferential surface 21 of the inner member 12 (described later) and restricts the movement of the inner member 12 in the radial direction. The lower-end inner circumferential surface 13a further includes an upper portion 13ab that defines a part of the flow path 30 (an inflow region 30a, described later) between it and the outer circumferential surface 21 of the inner member 12 (described later). The upper portion 13ab of the lower-end inner circumferential surface 13a is provided with fluid inlets 14 through which the fluid to be treated flows into the flow path 30. In this embodiment, there are provided two fluid inlets 14. The fluid inlets 14 are connected to a supply source (not illustrated) for pumping the fluid to be treated and allow the fluid to flow into the flow path 30 in the outer member 11. In this embodiment, the lower portion 13aa of the lower-end inner circumferential surface 13a has a smaller diameter than the upper portion 13ab; however, the embodiment is not so limited.

The female-threaded inner circumferential surface 13b of the outer member 11 is formed in a female thread shape and extends upward continuously from the lower-end inner circumferential surface 13a. The female-threaded inner circumferential surface 13b has a groove-like recess that is recessed outward in the radial direction and extends spirally in the vertical direction. The axial cross section of the female-threaded inner circumferential surface 13b has a shape in which peaks and valleys of the same size (shape) are alternately arranged one on top of another (see FIG. 1). In FIG. 1, the portion of the inner circumferential surface 13 between the uppermost dotted line and the lowermost dotted line corresponds to the female-threaded inner circumferential surface 13b of the outer member 11.

The tapered inner circumferential surface 13c of the outer member 11 is tapered and extends upward continuously from the female-threaded inner circumferential surface 13b. In this embodiment, the tapered inner circumferential surface 13c is tapered from the bottom to the top. The vertex of the tapered profile of the tapered inner circumferential surface 13c is located on the central axis CL.

As illustrated in FIG. 2, in this embodiment, the tapered inner circumferential surface 13c has two regions with different taper angles: an upper region and a lower region. Specifically, the tapered inner circumferential surface 13c has a lower region 15 with a larger taper angle θ1 and an upper region 16 with a taper angle θ2 smaller than that of the lower region 15 (θ1>θ2). In other words, the taper angle of the tapered inner circumferential surface 13c changes at a predetermined height position in the middle of the tapered inner circumferential surface 13c.

The upper-end inner circumferential surface 13d of the outer member 11 is located above the tapered inner circumferential surface 13c and extends upward continuously from the tapered inner circumferential surface 13c. In this embodiment, the upper-end inner circumferential surface 13d is formed to have a smaller diameter than the lower-end inner circumferential surface 13a. The upper-end inner circumferential surface 13d defines a space that extends in the vertical direction. The space serves as an outflow region 30d (described later), which is a part of the flow path 30. The upper end of the upper-end inner circumferential surface 13d continues to the upper end opening 11a of the outer member 11. The upper end opening 11a of the outer member 11 serves as an outlet through which the fluid flows out of the flow path 30.

As illustrated in FIG. 1, the outer member 11 is provided with a jacket 17 (space) through which other fluids can flow to adjust the temperature of the fluid to be treated (fluid) in the flow path 30. Examples of the other fluids include steam, hot water, cold water, gas (nitrogen gas, etc.), and other heat transfer media. In this embodiment, the jacket 17 is provided over the entire area between the height position of the lower end of the female-threaded inner circumferential surface 13b and the height position of the upper end of the tapered inner circumferential surface 13c in the outer member 11. The jacket 17 is provided with an inlet 18 at its lower end to allow the other fluids to flow therein. The jacket 17 is also provided with an outlet 19 at its upper end to allow the other fluids to flow out therefrom. In this embodiment, as illustrated in FIG. 1, a jacket forming member 20, which is formed separately from the outer member 11, is integrated with the outer member 11 while being spaced apart from the outer circumferential surface of the outer member 11, and thus the jacket 17 is formed along the outer circumferential surface of the outer member 11. The jacket 17 need not necessarily be provided in the manner described above. For example, a space may be provided within the thickness of the outer member 11 to serve as the jacket 17 without the use of the jacket forming member 20.

The inner member 12 is located radially inside the outer member 11 (the internal space of the outer member 11) and is assembled with the outer member 11. In this embodiment, the inner member 12 is inserted into the internal space of the outer member 11 through the lower end opening 11b of the outer member 11 and is threadedly assembled to the outer member 11. The inner member 12 has the outer circumferential surface 21 that defines the flow path 30 between it and the inner circumferential surface 13 of the outer member 11.

The inner member 12 of the embodiment has an internal space. The internal space of the inner member 12 serves as a jacket 22 through which the other fluids mentioned above can flow to adjust the temperature of the fluid to be treated (fluid) in the flow path 30. The jacket 22 is provided over the entire area of the inner member 12 in the vertical and radial directions. The inner member 12 has an inner lower surface 22a that defines the lower part of the jacket 22, and the inner lower surface 22a is provided with an inlet 23 to allow the other fluids to flow into the jacket 22. The inner lower surface 22a of the inner member 12 is further provided with an opening 25 at a position different from the inlet 23 (in this embodiment, at the center of the inner lower surface 22a) for inserting a cylindrical member 24. The cylindrical member 24 is secured to the inner member 12 while being inserted in the opening 25. The cylindrical member 24 has an upper end opening 24a, which is located near the upper end of the inner member 12 in the jacket 22. The cylindrical member 24 also has a lower end opening 24b, which is located below the opening 25 of the inner member 12 and serves as an outlet for the other fluids to flow out of the jacket 22. The fluid flowing through the jacket 22 of the inner member 12 may be the same fluid as that flowing through the jacket 17 of the outer member 11, or it may be a different fluid.

The outer circumferential surface 21 of the inner member 12 defines the radially inner side of the flow path 30 and includes three regions, one on top of another, each having a surface of a different shape. In other words, the outer circumferential surface 21 of the inner member 12 includes three differently shaped surfaces: a lower-end outer circumferential surface 21a, a male-threaded outer circumferential surface 21b, and a tapered outer circumferential surface 21c, in this order from bottom to top. That is, the inner member 12 has the tapered outer circumferential surface 21c in a portion thereof.

The lower-end outer circumferential surface 21a of the inner member 12 is located below the male-threaded outer circumferential surface 21b and extends continuously from the lower end of the inner member 12 to the lower end of the male-threaded outer circumferential surface 21b. The lower-end outer circumferential surface 21a includes a lower portion 21aa that is formed to have a slightly smaller diameter than the lower portion 13aa of the lower-end inner circumferential surface 13a of the outer member 11. The lower portion 21aa of the lower-end outer circumferential surface 21a faces the lower portion 13aa of the lower-end inner circumferential surface 13a of the outer member 11 from the radially inside in a state of being in close proximity to or in contact with the lower portion 13aa. The lower portion 21aa of the lower-end outer circumferential surface 21a restricts the movement of the inner member 12 in the radial direction with respect to the outer member 11 and positions the inner member 12. The lower portion 21aa of the lower-end outer circumferential surface 21a is provided with a sealing member 33 (e.g., an O-ring) to restrict the flow of fluid downward from the side of the flow path 30 located above. The lower-end outer circumferential surface 21a further includes an upper portion 21ab that faces the upper portion 13ab of the lower-end inner circumferential surface 13a of the outer member 11 from the radially inside in a state of being spaced radially inward from the upper portion 13ab. The upper portion 21ab of the lower-end outer circumferential surface 21a defines a space to be a part of the flow path 30 (the inflow region 30a, described later) between it and the upper portion 13ab of the lower-end inner circumferential surface 13a of the outer member 11. The fluid inlets 14 in the lower-end inner circumferential surface 13a of the outer member 11 communicate with this space. In this embodiment, the lower portion 21aa of the lower-end outer circumferential surface 21a has a larger diameter than the upper portion 21ab; however, the embodiment is not so limited.

The male-threaded outer circumferential surface 21b of the inner member 12 is formed in a male thread shape and extends upward continuously from the lower-end outer circumferential surface 21a. The male-threaded outer circumferential surface 21b faces the female-threaded inner circumferential surface 13b of the outer member 11 from the radially inside. The male-threaded outer circumferential surface 21b has threads formed at the same pitch as those of the female-threaded inner circumferential surface 13b of the outer member 11 so that it can be threadedly assembled with the female-threaded inner circumferential surface 13b. In other words, the male-threaded outer circumferential surface 21b corresponds to the female-threaded inner circumferential surface 13b. The male-threaded outer circumferential surface 21b has a raised portion that is raised outward in the radial direction and extends spirally in the vertical direction. The axial cross section of the male-threaded outer circumferential surface 21b has a shape in which peaks and valleys of the same size (shape) are alternately arranged one on top of another (see FIG. 1). In FIG. 1, the portion of the outer circumferential surface 21 between the uppermost dotted line and the lowermost dotted line corresponds to the male-threaded outer circumferential surface 21b of the inner member 12.

The thread angle θ3 of the male-threaded outer circumferential surface 21b is set to be larger than the thread angle θ4 of the female-threaded inner circumferential surface 13b (θ3>θ4). That is, the male-threaded outer circumferential surface 21b and the female-threaded inner circumferential surface 13b have different shapes due to the different angles of their threads. The bottom of each valley portion 26 of the male-threaded outer circumferential surface 21b having the smallest outer diameter is in close proximity to or in contact with the top of each peak portion 27 of the female-threaded inner circumferential surface 13b having the smallest inner diameter. On the other hand, the top of each peak portion 28 of the male-threaded outer circumferential surface 21b having the largest outer diameter is separated from the bottom of each valley portion 29 of the female-threaded inner circumferential surface 13b having the largest outer diameter. As a result, a spiral first region 30b of the flow path 30 (described later) is defined between the peaks of the male-threaded outer circumferential surface 21b and the valleys of the female-threaded inner circumferential surface 13b.

The tapered outer circumferential surface 21c of the inner member 12 is tapered and extends upward continuously from the male-threaded outer circumferential surface 21b. In this embodiment, the tapered outer circumferential surface 21c is tapered from the bottom to the top and faces the tapered inner circumferential surface 13c of the outer member 11 from the radially inside in a state of being spaced apart from the tapered inner circumferential surface 13c. As a result, a second region 30c of the flow path 30 (described later) is defined between the tapered outer circumferential surface 21c and the tapered inner circumferential surface 13c. In this embodiment, the inner member 12 is formed such that the vertex of the tapered profile of the tapered outer circumferential surface 21c is the upper end of the inner member 12. The vertex of the tapered profile of the tapered outer circumferential surface 21c is located on the central axis CL. The top of the upper end of the inner member 12 is located in a space (the outflow region 30d of the flow path 30) defined by the upper-end inner circumferential surface 13d of the outer member 11.

As illustrated in FIG. 2, in this embodiment, the taper angle θ5 of the tapered outer circumferential surface 21c is set to be constant from the upper end to the lower end, differently from the tapered inner circumferential surface 13c. The taper angle θ5 of the tapered outer circumferential surface 21c is set to be the same as the taper angle θ2 of the upper region 16 of the tapered inner circumferential surface 13c (θ5=θ2).

Next, the assembly process of the outer member 11 and inner member 12 will be described. To assemble the outer member 11 and the inner member 12, the inner member 12 is inserted into the lower end opening 11b of the outer member 11 from the tapered outer circumferential surface 21c side, and the upper end side of the male-threaded outer circumferential surface 21b of the inner member 12 and the lower end side of the female-threaded inner circumferential surface 13b of the outer member 11 are brought into contact. Next, the outer member 11 and the inner member 12 are rotated relative to each other so that the male-threaded outer circumferential surface 21b and the female-threaded inner circumferential surface 13b are screwed together to threadedly assemble the outer member 11 and inner member 12. The clearance distance between the tapered outer circumferential surface 21c and the tapered inner circumferential surface 13c can be adjusted at this time. The adjustment of the clearance distance will be described later.

The flow path 30 is defined between the inner circumferential surface 13 of the outer member 11 and the outer circumferential surface 21 of the inner member 12, through which the fluid to be treated flows from the lower side to the upper side. The flow path has four regions with different shapes and functions. Specifically, the flow path 30 has four regions: the inflow region 30a, the first region 30b, the second region 30c, and the outflow region 30d, in this order from bottom to top.

The inflow region 30a of the flow path 30 is defined between the upper portion 21ab of the lower-end outer circumferential surface 21a of the inner member 12 and the upper portion 13ab of the lower-end inner circumferential surface 13a of the outer member 11. The inflow region 30a is a space through which the fluid to be treated flowing into the flow path 30 first passes. The inflow region 30a of the flow path 30 communicates with the fluid inlets 14 in the lower-end inner circumferential surface 13a of the outer member 11.

The first region 30b of the flow path 30 is defined between the peaks of the male-threaded outer circumferential surface 21b of the inner member 12 and the valleys of the female-threaded inner circumferential surface 13b of the outer member 11, and extends spirally from the lower side to the upper side. The size of the path in the first region 30b of the flow path 30 is determined by the shapes of the female-threaded inner circumferential surface 13b and the male-threaded outer circumferential surface 21b. In other words, the area of the path in the first region 30b of the flow path 30 is defined by the shapes of the female-threaded inner circumferential surface 13b and the male-threaded outer circumferential surface 21b. The first region 30b is located above the inflow region 30a and communicates with the inflow region 30a. The first region 30b serves as a pre-dispersion section where a pre-dispersion process is performed on the fluid to be treated prior to a fine dispersion process. Incidentally, pre-dispersion refers to a process in which the fluid to be treated is uniformly atomized to some extent, although the particles obtained are larger than the target product.

The second region 30c of the flow path 30 is defined between the tapered outer circumferential surface 21c of the inner member 12 and the tapered inner circumferential surface 13c of the outer member 11 and extends upward continuously from the first region 30b. That is, the flow path 30 includes the first region 30b extending spirally from the lower side to the upper side and the second region 30c extending upward continuously from the first region 30b. The diameter of the second region 30c decreases from the lower side to the upper side. The second region 30c includes: a reduction region 30ca defined between the lower region 15 of the tapered inner circumferential surface 13c and the tapered outer circumferential surface 21c; and a constant region 30cb defined between the upper region 16 of the tapered inner circumferential surface 13c and the tapered outer circumferential surface 21c (see FIG. 2). The reduction region 30ca is a portion of the second region 30c where the clearance distance (e.g., the separation distance between the tapered outer circumferential surface 21c and the tapered inner circumferential surface 13c in the direction perpendicular to the tapered outer circumferential surface 21c) decreases from the lower side to the upper side. The constant region 30cb is a portion of the second region 30c where the clearance distance L1 is constant from the lower side to the upper side. In other words, in this embodiment, the clearance distance in the second region 30c gradually decreases from the lower side to the upper side and remains constant above a predetermined height position. In this manner, in the disperser 10, the tapered inner circumferential surface 13c and the tapered outer circumferential surface 21c are formed such that the angle of one with respect to the other in the axial cross section changes in the middle of the second region 30c (at a predetermined height position), and thus the second region 30c of the flow path 30 has portions with different clearance distances between the tapered inner circumferential surface 13c and the tapered outer circumferential surface 21c (in this embodiment, the reduction region 30ca and the constant region 30cb). The second region 30c is located above the first region 30b and communicates with the first region 30b. The second region 30c serves as a fine dispersion section where a fine dispersion process is performed on the material to be treated that has been pre-dispersed in the first region 30b. Incidentally, fine dispersion refers to a process in which a greater shear force is applied to the pre-dispersed material than in the pre-dispersion process to obtain fine particles of the desired size. In the following, the term “clearance distance”, when simply referred to as “clearance distance”, refers to the separation distance between the tapered outer circumferential surface 21c and the tapered inner circumferential surface 13c. Meanwhile, when referred to as “clearance distance L1”, it refers to the clearance distance in the constant region 30cb of the flow path 30 (the separation distance between the tapered outer circumferential surface 21c and the upper region 16 of the tapered inner circumferential surface 13c).

In the constant region 30cb of the second region 30c, the clearance distance L1 is preferably 0.1 μm or more and 2 mm or less. In addition, the length L2 (see FIG. 2) of the constant region 30cb of the second region 30c from the lower side to the upper side along the flow path direction (the flow path direction in the axial cross section) is preferably 1 mm or more, more preferably 3 mm or more, and particularly preferably 5 mm or more.

The outflow region 30d of the flow path 30 is defined by the upper-end inner circumferential surface 13d of the outer member 11. The outflow region 30d is located above the second region 30c, and its lower part communicates with the second region 30c, while its upper part communicates with the upper end opening 11a of the outer member 11. In the outflow region 30d, the treated material that has been finely dispersed in the second region 30c is guided to the upper end opening 11a and discharged therefrom.

In this embodiment, when the axial direction corresponds to the vertical direction, the inner circumferential surface 13 of the outer member 11 and the outer circumferential surface 21 of the inner member 12 have no horizontal portion where fluid flowing through the flow path 30 may accumulate. Specifically, when the axial direction corresponds to the vertical direction, the inner circumferential surface 13 of the outer member 11 and the outer circumferential surface 21 of the inner member 12 do not have a horizontal upper surface. In particular, when the axial direction corresponds to the vertical direction, the surfaces that define the first region 30b and the second region 30c of the flow path 30, i.e., the male-threaded outer circumferential surface 21b and the tapered outer circumferential surface 21c of the inner member 12, the female-threaded inner circumferential surface 13b and the tapered inner circumferential surface 13c of the outer member 11, have no horizontal portion where the fluid flowing through the flow path 30 may accumulate.

The material for the inner circumferential surface 13 of the outer member 11 and the outer circumferential surface 21 of the inner member 12 may be selected from metal or the like as appropriate, depending on the type of fluid to be treated. For example, the material may be SUS316L that has been buffed and then electrolytically polished. Although it is preferred that the regions of the inner circumferential surface 13 of the outer member 11 and the outer circumferential surface 21 of the inner member 12 that define the constant region 30cb of the second region 30c of the flow path 30 (shaded regions on both sides of the constant region 30cb in FIG. 2) be made of ceramic such as silicon carbide, tungsten carbide, or alumina to prevent seizure, diamond-like carbon or the like may be used instead. In addition, it is preferred that the inner circumferential surface 13 of the outer member 11 and the outer circumferential surface 21 of the inner member 12, which define the flow path 30, be coated with a corrosion-resistant material. Examples of coatings made of corrosion-resistant materials include glass-lined coatings, fluoropolymer coatings, and ceramic coatings; fluoropolymer coatings are preferred.

Next, a description will be given of the flow of the fluid to be treated when the disperser 10 performs the dispersion process or the like.

As indicated by the white arrow in FIG. 1, the fluid to be treated is first pumped from the supply source side (not illustrated) and flows into the inflow region 30a of the flow path 30 from the fluid inlets 14 of the outer member 11 located at the lower part of the disperser 10. After flowing through the inflow region 30a, the fluid then flows therefrom into the spiral first region 30b located above.

Having flowed into the first region 30b, the fluid flows upward through the spiral first region 30b while circulating around the inner member 12 in a spiral manner. As the fluid spirals upward, it is subjected to centrifugal force, which facilitates the creation of a turbulent flow condition, thereby increasing the Reynolds number. The centrifugal force and Reynolds number can be easily changed by controlling the flow rate or the like of the spirally circulating fluid, which enables the control of the shear force applied to the fluid, and thus a required pre-dispersed treated material (hereinafter, “pre-dispersed material”) can be obtained. In this manner, the first region 30b of the flow path 30 serves as a pre-dispersion section where a pre-dispersion process is performed on the fluid to be treated prior to a fine dispersion process. At this time, the pressure drop is very small. The pre-dispersed material obtained by pre-dispersion in the first region 30b flows from the first region 30b into the second region 30c.

Having flowed into the second region 30c, the pre-dispersed material first flows through the reduction region 30ca of the second region 30c. In the reduction region 30ca of the second region 30c, the pre-dispersed material moves upward while circulating in the circumferential direction along the tapered inner circumferential surface 13c and the tapered outer circumferential surface 21c. The movement rate of the pre-dispersed material increases as the diameters of the tapered inner circumferential surface 13c and the tapered outer circumferential surface 21c decrease. As the pre-dispersed material moves upward, the clearance distance decreases. As a result, the pre-dispersed material is further accelerated to be subjected to a shear force and guided to the constant region 30cb while being dispersed. After flowing into the constant region 30cb, the pre-dispersed material is accelerated due to the clearance distance L1 set appropriately and subjected to a shear force to be atomized into even smaller fine particles, and thus a finely dispersed treated material (hereinafter, “finely dispersed material”) can be obtained. In this manner, the second region 30c of the flow path 30 serves as a fine dispersion section where a fine dispersion process is performed on the pre-dispersed material that has been pre-dispersed in the first region 30b. That is, according to the present disclosure, the disperser 10 continuously performs the pre-dispersion process and the fine dispersion process.

Next, a method of using the disperser 10 will be described.

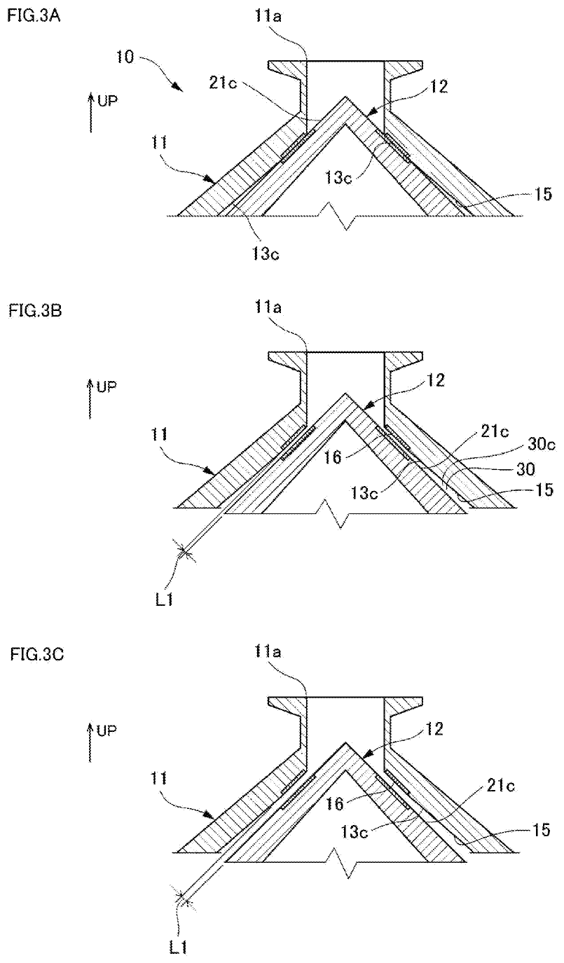

FIGS. 3A to 3C are diagrams for explaining the states of the disperser: FIG. 3A illustrates a contact state, FIG. 3B illustrates a use state, and FIG. 3C illustrates a separate state.

First, it will be described how to adjust the clearance distance L1 in the constant region 30cb of the flow path 30 to place the disperser 10 in the use state, and then how to clean or sterilize the disperser 10.

To adjust the clearance distance L1 in the constant region 30cb of the flow path 30, first, the outer member 11 and the inner member 12 are rotated relative to each other to bring the disperser 10 into the contact state where the tapered outer circumferential surface 21c of the inner member 12 and the tapered inner circumferential surface 13c of the outer member 11 are in contact with each other (clearance distance L1=0) (see FIG. 3A). Thereafter, the outer member 11 and the inner member 12 are rotated relative to each other in a direction opposite to the direction of bringing them into contact such that the clearance distance L1 becomes a desired one to bring the disperser 10 into the use state (see FIG. 3B). In this manner, the tapered outer circumferential surface 21c and the tapered inner circumferential surface 13c are separated from the contact state. Therefore, in contrast to the case where the tapered outer circumferential surface 21c and the tapered inner circumferential surface 13c are adjusted in the direction of bringing them closer together, the clearance distance L1 in the constant region 30cb of the flow path 30 can be finely adjusted. Thus, it is possible to set the clearance distance L1 to a desired one and to place the disperser 10 in the use state.

As described above, the outer member 11 and the inner member 12 are configured to be threadedly assembled. Accordingly, the disperser 10 can be brought into the contact state where the tapered outer circumferential surface 21c and the tapered inner circumferential surface 13c are in contact with each other (see FIG. 3A) by rotating the outer member 11 and the inner member 12 relative to each other. By rotating the outer member 11 and the inner member 12 relative to each other from the contact state, the disperser 10 can be placed in the use state where it is used and the clearance distance L1 is small (see FIG. 3B). In addition, by further rotating the outer member 11 and the inner member 12 relative to each other from the use state, the disperser 10 can be placed in the separate state where the clearance distance L1 is larger than in the use state (see FIG. 3C). That is, the disperser 10 of the embodiment can be selectively placed in any one of the contact state, the use state, and the separate state without disassembling the outer member 11 and the inner member 12.

To clean or sterilize the disperser 10, the outer member 11 and the inner member 12 are rotated relative to each other to bring the disperser 10 from the use state into the separate state (see FIG. 3C). Thereby, the tapered inner circumferential surface 13c and the tapered outer circumferential surface 21c can be separated to an extent that allows cleaning or sterilization. Thus, the disperser 10 can be cleaned and sterilized in place without disassembling the outer member 11 and the inner member 12.

In the disperser 10 configured as described above, the flow path 30 includes the first region 30b that extends spirally from the lower side to the upper side, and the first region 30b serves as a pre-dispersion section where a pre-dispersion process is performed on the fluid to be treated prior to a fine dispersion process. In this manner, the disperser 10 performs a pre-dispersion process on the fluid to be treated before performing a fine dispersion process to obtain a pre-dispersed material.

The flow path 30 also includes the second region 30c, which is defined by the tapered inner circumferential surface 13c and the tapered outer circumferential surface 21c and extends upward continuously from the first region 30b. Accordingly, the pre-dispersed material moves upward while circulating in the circumferential direction along the tapered inner circumferential surface 13c and the tapered outer circumferential surface 21c. The pre-dispersed material moves faster as the diameters of the tapered inner circumferential surface 13c and the tapered outer circumferential surface 21c decrease. Thus, the pre-dispersion process and the fine dispersion process can be performed continuously, and a finely dispersed material (e.g., nanoparticles) can be obtained by performing the fine dispersion process on the pre-dispersed material.

In addition, the tapered inner circumferential surface 13c and the tapered outer circumferential surface 21c are formed such that the angle of one with respect to the other in the axial cross section changes in the middle of the second region 30c. As a result, the second region 30c of the flow path 30 has portions with different clearance distances between the tapered inner circumferential surface 13c and the tapered outer circumferential surface 21c (in this embodiment, the reduction region 30ca and the constant region 30cb). With this, the pre-dispersed material can be further accelerated by appropriately setting the clearance distance to efficiently apply a large shear force to the fluid to be treated (pre-dispersed material) and perform the fine dispersion process to obtain a finely dispersed material (e.g., nanoparticles). For example, when the second region 30c is provided with the reduction region 30ca and the constant region 30cb as described above, the pre-dispersed material can be guided to the constant region 30cb while being accelerated and dispersed in the reduction region 30ca and further accelerated and dispersed in the constant region 30cb to obtain a finely dispersed material (e.g., nanoparticles).

In the disperser 10, the fluid to be treated moves (spirals) with respect to the outer member 11 and the inner member 12. As a result, in contrast to the case where the outer member 11 and the inner member 12 are rotated relative to each other to apply a shear force to the fluid to be treated, a finely dispersed material can be obtained from the fluid with low power.

In the disperser 10, the flow path 30 includes the first region 30b serving as a pre-dispersion section and the second region 30c serving as a fine dispersion section. Therefore, in contrast to the case where fine dispersion or finishing dispersion is performed using a separate device after pre-dispersion, a compact configuration can be achieved.

Moreover, since the outer member 11 and the inner member 12 are configured to be threadedly assembled, they can be easily disassembled by rotating them in the opposite direction. This facilitates the application of a coating to the tapered inner circumferential surface 13c and the tapered outer circumferential surface 21c that define the flow path 30.

Furthermore, when the axial direction corresponds to the vertical direction, the inner circumferential surface 13 of the outer member 11 and the outer circumferential surface 21 of the inner member 12 have no horizontal portion where fluid flowing through the flow path 30 may accumulate. This prevents any cleaning agent (condensed water of pure steam, etc.) from remaining in the flow path 30 at the time of cleaning, for example, the inner circumferential surface 13 of the outer member 11 and the outer circumferential surface 21 of the inner member 12.

In contrast to the case where the outer member 11 and the inner member 12 are rotated relative to each other to apply a shear force to the fluid to be treated, there are no sliding parts that slide against each other between the outer member 11 and the inner member 12. Therefore, it is possible to simplify the structure and suppress the generation of foreign substances. Since the disperser 10 can suppress the generation of foreign substances and can be cleaned and sterilized in place as described above, it can be used for pharmaceutical manufacturing equipment (in particular, injection manufacturing equipment).

Specifically, the processes of producing pharmaceuticals, cosmetics, food, chemical products, electronic components, and the like often include a dispersion process that produces fine particles such as nanocrystals, nanoemulsions, liposomes, and nanospheres. There are various requirements for a disperser that enables the production of such fine particles, especially nanoparticles. For example, a disperser used to produce vaccines such as new coronavirus vaccines must be cleaned and sterilized in place without disassembling its parts to eliminate human error, because the vaccines are injections. In addition, since pure steam or the like flows through the flow path 30 during sterilization, thermal countermeasures are required for the inner circumferential surface 13 of the outer member 11 and the outer circumferential surface 21 of the inner member 12 that define the flow path 30. There is also a need to drain condensed water of pure steam without leaving residue. As described above, the disperser 10 of the present disclosure can satisfy these requirements.

It is also required to reliably prevent foreign substances (e.g., foreign substances generated from sliding parts, etc.) from mixing with the finely dispersed material. For this reason, it is difficult to use a dispersing device such as a bead mill or an ultrasonic oscillator. In a bead mill, foreign substances such as bead fragments and wear debris may be generated and mixed into the material being treated. In an ultrasonic disperser, erosion occurs due to cavitation, resulting in the generation of foreign substances, which may be mixed into the material being treated. As described above, the disperser 10 of the present disclosure can satisfy these requirements.

Incidentally, manufacturers of pharmaceuticals and similar products are required to perform validation to verify that their pharmaceuticals and medical devices are manufactured using the correct processes and methods. As described above, the disperser 10 of the present disclosure can satisfy various requirements for a disperser used in the production of pharmaceutical products or the like, and therefore it can also satisfy requirements for validation.

As described above, according to the embodiment, shear force can be efficiently applied to a material to be treated with low power to produce fine particles, particularly nanoparticles.

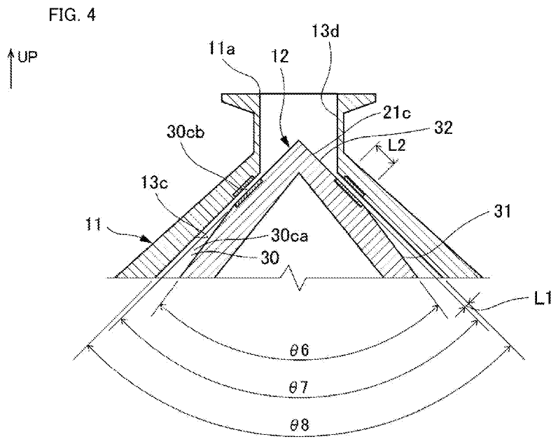

According to the embodiment, the tapered inner circumferential surface 13c of the outer member 11 has two regions (the lower region 15 and the upper region 16) with different taper angles, while the tapered outer circumferential surface 21c of the inner member 12 has a constant taper angle from the upper end to the lower end, thereby providing the second region 30c of the flow path 30 with the reduction region 30ca and the constant region 30cb; however, the embodiment is not so limited. FIG. 4 is an enlarged view illustrating a modification of the second region 30c of the flow path 30 and corresponds to FIG. 2. For example, as illustrated in FIG. 4, the tapered outer circumferential surface 21c of the inner member 12 may have a lower region 31 with a smaller taper angle θ6 and an upper region 32 with a taper angle θ7 larger than that of the lower region 31 (θ6<θ7). In addition, the tapered inner circumferential surface 13c of the outer member 11 may have a taper angle θ8 that is constant from the upper end to the lower end, and the taper angle θ8 may be set to be the same as the taper angle θ7 of the upper region 32 of the tapered outer circumferential surface 21c. In this manner, the second region 30c of the flow path 30 may be provided with the reduction region 30ca and the constant region 30cb.

According to the embodiment, the tapered inner circumferential surface 13c and the tapered outer circumferential surface 21c are formed such that the angle of one with respect to the other in the axial cross section changes in the middle of the second region 30c, and they form two different angles; however, the embodiment is not so limited. The tapered inner circumferential surface 13c and the tapered outer circumferential surface 21c only need to form at least two different angles in the axial cross section, and they may form three or more different angles.

According to the embodiment, one of the tapered inner circumferential surface 13c and the tapered outer circumferential surface 21c has a taper angle which changes at a predetermined height position in the axial cross section, and the other has a taper angle which is constant from the upper end to the lower end; however, the embodiment is not so limited. For example, the taper angles of both the tapered inner circumferential surface 13c and the tapered outer circumferential surface 21c may be changed at a predetermined height position so that the second region 30c of the flow path 30 is provided with portions having different clearance distances.

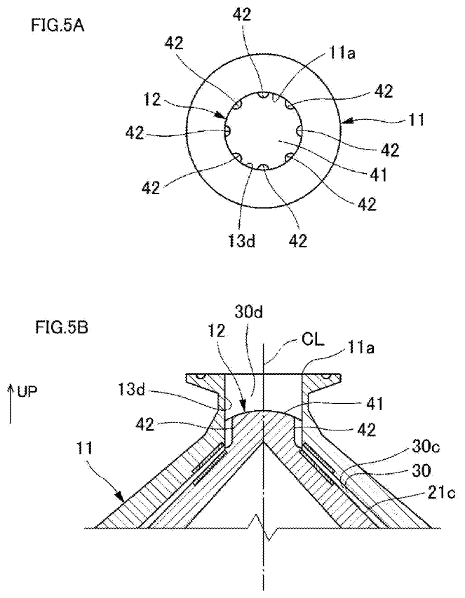

According to the embodiment, the inner member 12 is formed such that the vertex of the tapered profile of the tapered outer circumferential surface 21c is the upper end of the inner member 12; however, the embodiment is not so limited. FIGS. 5A and 5B are diagrams for explaining a modification of the top portion of the inner member 12: FIG. 5A illustrates a state as viewed from above in the axial direction, and FIG. 5B illustrates an axial cross section. For example, as illustrated in FIGS. 5A and 5B, the inner member 12 may have a positioning top portion 41 at the upper end above the tapered outer circumferential surface 21c. The positioning top portion 41 is concentric with the upper-end inner circumferential surface 13d of the outer member 11 and is formed into a substantially cylindrical shape having a diameter slightly smaller than that of the upper-end inner circumferential surface 13d. The positioning top portion 41 is inserted from below into the outflow region 30d of the flow path 30 defined by the upper-end inner circumferential surface 13d of the outer member 11. The positioning top portion 41 has a plurality of grooves 42 that are recessed radially inward from the outer circumferential surface and extend in the vertical direction. The grooves 42 are arranged on the positioning top portion 41 to be spaced apart at equal intervals in the circumferential direction. Each of the grooves 42 defines a space that extends upward continuously from the upper end of the second region 30c of the flow path 30 to the upper end of the positioning top portion 41 between it and the upper-end inner circumferential surface 13d of the outer member 11. Thus, the upper end and the lower end of the inner member 12 are supported while being restrained from moving in the radial direction by the outer member 11, thereby allowing the inner member 12 to be securely positioned.

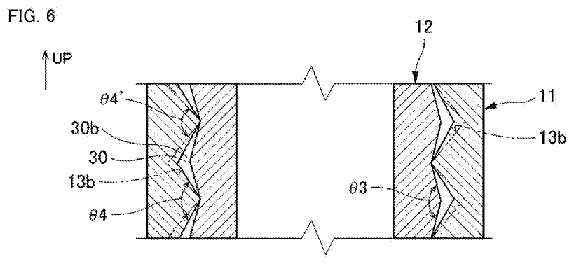

In addition, the area of the spiral first region 30b of the flow path 30 can be changed by providing a different combination of the thread angle θ3 of the male-threaded outer circumferential surface 21b of the inner member 12 and the thread angle θ4 of the female-threaded inner circumferential surface 13b of the outer member 11. FIG. 6 is a diagram for explaining the area of the first region 30b of the flow path 30. Note that FIG. 6 illustrates an axial cross section of the first region 30b of the above embodiment. For example, as indicated by the dash-dot-dot line in FIG. 6, the area of the first region 30b can be expanded by replacing the outer member 11 with one in which the thread angle θ4′ of the female-threaded inner circumferential surface 13b is smaller than the thread angle θ4 of the above embodiment. The outer member 11 may also be replaced with one in which the thread angle θ4′ of the female-threaded inner circumferential surface 13b is larger than the thread angle θ4 of the above embodiment. Similarly, the inner member 12 may be replaced with one in which the thread angle θ3 of the male-threaded outer circumferential surface 21b is different (larger or smaller) than that of the above embodiment.

Furthermore, the male-threaded outer circumferential surface 21b of the inner member 12 and the female-threaded inner circumferential surface 13b of the outer member 11 may be multi-threaded with two or more threads. In this case, for example, an oil-based component and a water-based component may be flowed through different spiral flow paths (the first region 30b of the flow path 30), separately adjusted/homogenized and pre-dispersed, and then finely dispersed in the same second region 30c to obtain an emulsion.

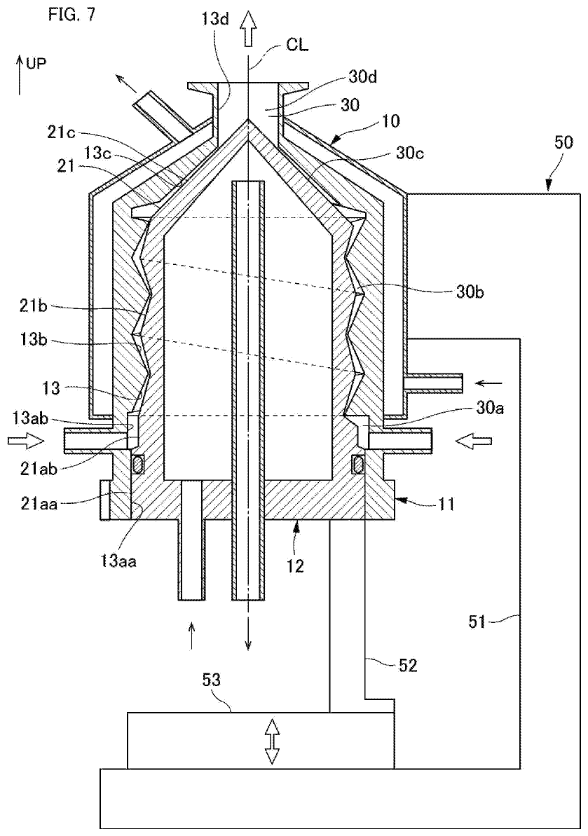

According to the embodiment, the clearance distance L1 in the constant region 30cb of the flow path 30 is adjusted by rotating the outer member 11 and the inner member 12 relative to each other; however, the embodiment is not so limited. For example, as illustrated in FIG. 7, a precision positioning device 50 may be connected to the disperser 10 to adjust the clearance distance L1. FIG. 7 is a diagram illustrating the disperser 10 to which the precision positioning device 50 is connected. As illustrated in FIG. 7, the precision positioning device 50 includes a first member 51 connected to the outer member 11 of the disperser 10, a second member 52 connected to the inner member 12 of the disperser 10, and a precision adjustment part 53 located between the first member 51 and the second member 52. The first member 51 is connected to the outer member 11 while being restrained from moving in the vertical direction with respect to the outer member 11. The second member 52 is connected to the outer member 11 while being restrained from moving in the vertical direction with respect to the inner member 12. In the example of FIG. 7, the first member 51 is arranged on the side of the outer member 11 to support the outer member 11, and the second member 52 is arranged below the inner member 12 to support the inner member 12 from below. The precision adjustment part 53 has a mechanism (e.g., an actuator, etc., not illustrated) that can move the outer member 11 and the inner member 12 relative to each other in the vertical direction, as indicated by the white arrow. The precision adjustment part 53 can precisely adjust the clearance distance L1 in the constant region 30cb of the flow path 30 by moving the outer member 11 and the inner member 12 relative to each other in the vertical direction. In this case, it is preferable that the outer member 11 and the inner member 12 be able to move slightly relative to each other in the vertical direction without relative rotation, for example, by setting a larger backlash (also called lash) between the male-threaded outer circumferential surface 21b of the inner member 12 and the female-threaded inner circumferential surface 13b of the outer member 11. Even if the backlash between the male-threaded outer circumferential surface 21b of the inner member 12 and the female-threaded inner circumferential surface 13b of the outer member 11 is set larger, the fluid to be treated rises in the first region 30b of the flow path 30 under centrifugal force. Therefore, the effect on the spiral flow is small, and the spiral flow can be sufficiently adjusted by increasing the number of threads on the male-threaded outer circumferential surface 21b and the female-threaded inner circumferential surface 13b.

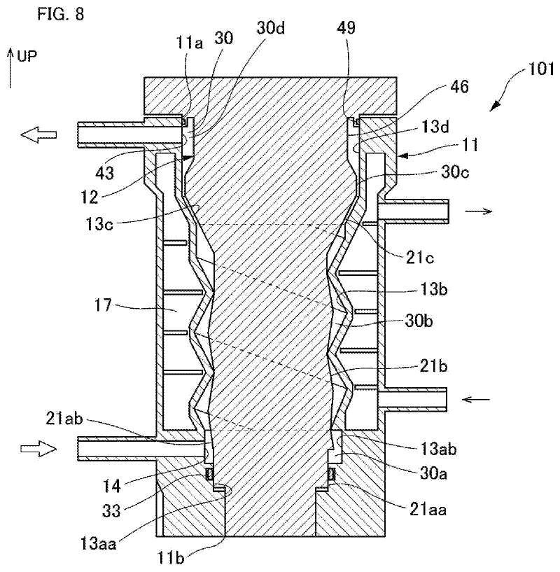

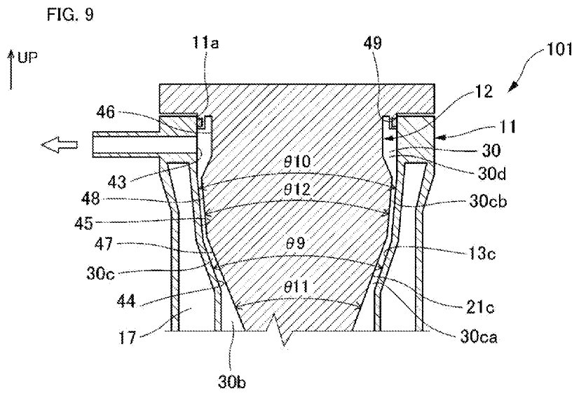

According to the embodiment, the outer member 11 and the inner member 12 have the tapered inner circumferential surface 13c and the tapered outer circumferential surface 21c, respectively, which taper from the bottom to the top; however, the embodiment is not so limited. FIG. 8 is an axial sectional view illustrating a modification of the disperser. FIG. 9 is an enlarged view of the main parts of the disperser illustrated in FIG. 8. Like reference numerals are used to designate like parts or elements as those in the above embodiment.

For example, as illustrated in FIGS. 8 and 9, the tapered inner circumferential surface 13c of the outer member 11 and the tapered outer circumferential surface 21c of the inner member 12 may be tapered from the top to the bottom. In a disperser 101 illustrated in FIGS. 8 and 9, the upper end opening 11a of the outer member 11 is formed to have a larger diameter than the lower end opening 11b, and it serves as an insertion port for inserting the inner member 12 into the outer member 11. The upper end opening 11a of the outer member 11 is closed from above by the upper end of the inner member 12. The inner member 12 is inserted into the outer member 11 from the upper end opening 11a, and part of its upper end is fitted in the outflow region 30d of the flow path 30 so that the inner member 12 can be positioned and restrained from moving in the radial direction with respect to the outer member 11. A sealing member 49 (e.g., an O-ring) is provided between the upper-end inner circumferential surface 13d of the outer member 11 around the upper end opening 11a and the upper end of the inner member 12 to prevent the fluid from flowing upward from the outflow region 30d of the flow path 30. The upper-end inner circumferential surface 13d of the outer member 11 is provided with an outlet 43 for allowing a finely dispersed material to flow out of the flow path 30. The outer circumferential surface 21 of the inner member 12 includes a cylindrical upper-end outer circumferential surface 46 that extends upward continuously from the tapered outer circumferential surface 21c. The upper-end outer circumferential surface 46 of the inner member 12 faces the upper-end inner circumferential surface 13d of the outer member 11 at a position spaced radially inward from the upper-end inner circumferential surface 13d. The outflow region 30d of the flow path 30 is defined between the upper-end outer circumferential surface 46 of the inner member 12 and the upper-end inner circumferential surface 13d of the outer member 11. The tapered inner circumferential surface 13c and the tapered outer circumferential surface 21c each have two regions with different taper angles: an upper region and a lower region. Specifically, the tapered inner circumferential surface 13c has a lower region 44 with a larger taper angle θ9 and an upper region 45 with a taper angle θ10 smaller than that of the lower region 44 (θ9>θ10). The tapered outer circumferential surface 21c has a lower region 47 with a larger taper angle θ11 and an upper region 48 with a taper angle θ12 smaller than that of the lower region 47 (θ11>θ12). The taper angle θ11 of the lower region 47 of the tapered outer circumferential surface 21c is set smaller than the taper angle θ9 of the lower region 44 of the tapered inner circumferential surface 13c. Meanwhile, the taper angle θ12 of the upper region 48 of the tapered outer circumferential surface 21c is set to be the same as the taper angle θ10 of the upper region 45 of the tapered inner circumferential surface 13c. As a result, the second region 30c of the flow path 30 has the reduction region 30ca where the clearance distance decreases from the lower side to the upper side and the constant region 30cb where the clearance distance L1 is constant from the lower side to the upper side. In this case, the second region 30c of the flow path 30 expands in the radial direction toward the top. Therefore, in contrast to the case where the second region 30c becomes smaller in the radial direction toward the top, the flow direction of the material to be treated can be prevented from coinciding with the axial direction. Thus, the flow direction can be maintained in a spiral direction. This suppresses the pressure drop and allows the material to be treated to remain in the second region 30c for a longer time to be more finely dispersed.

While preferred embodiments of the invention have been described and illustrated, the invention is not limited to the embodiments disclosed herein. Various changes, modifications, and alterations may be made within the scope of the invention as defined in the appended claims. That is, many variations and modifications thereof may be made by those skilled in the art without departing from the spirit and scope of the invention. All such variations and modifications are intended to be included within the scope of the invention as defined in the appended claims.

### LIST OF REFERENCE SIGNS

10, 101 Disperser
11 Outer member
12 Inner member
13 Inner circumferential surface
13b Female-threaded inner circumferential surface
13c Tapered inner circumferential surface
17, 22 Jacket
21 Outer circumferential surface
21b Male-threaded outer circumferential surface
21c Tapered outer circumferential surface
30 Flow path
30b First region
30c Second region
30ca Reduction region
30cb Constant region

1. A disperser, comprising:
a cylindrical outer member having a tapered inner circumferential surface in a portion thereof; and
an inner member located radially inside the outer member and having a tapered outer circumferential surface in a portion thereof, the tapered outer circumferential surface facing the tapered inner circumferential surface of the outer member; wherein
a flow path is formed between the outer member and the inner member, through which fluid flows from one side to an other side in the axial direction,
the flow path includes a first region that extends spirally from the one side to the other side and a second region that extends continuously from the first region to the other side,
the second region of the flow path is defined by the tapered inner circumferential surface and the tapered outer circumferential surface, and
the tapered inner circumferential surface and the tapered outer circumferential surface are formed such that an angle therebetween in an axial cross section changes in a middle of the second region, and the second region of the flow path has portions each having a different clearance distance between the tapered inner circumferential surface and the tapered outer circumferential surface.

2. The disperser according to claim 1, wherein
the outer member has a female-threaded inner circumferential surface located on the one side of the tapered inner circumferential surface,
the inner member has a male-threaded outer circumferential surface located on the one side of the tapered outer circumferential surface and corresponding to the female-threaded inner circumferential surface, and is threadedly assembled to the outer member,
the first region of the flow path is defined by the female-threaded inner circumferential surface and the male-threaded outer circumferential surface, and
an area of the first region of the flow path is defined by shapes of the female-threaded inner circumferential surface and the male-threaded outer circumferential surface.

3. The disperser according to claim 1, wherein the second region of the flow path includes:
a reduction region where the clearance distance decreases from the one side to the other side, and
a constant region extending continuously from the reduction region to the other side, where the clearance distance is constant.

4. The disperser according to claim 3, wherein the constant region of the second region of the flow path has a length of 1 mm or more from the one side to the other side along a flow path direction in the axial cross section.

5. The disperser according to claim 2, wherein the female-threaded inner circumferential surface and the male-threaded outer circumferential surface have different shapes due to different thread angles.

6. The disperser according to claim 3, wherein in the constant region of the second region of the flow path, the clearance distance is 0.1 μm or more and 2 mm or less.

7. The disperser according to claim 3, wherein regions of the tapered inner circumferential surface and the tapered outer circumferential surface that define the constant region of the second region of the flow path are made of ceramic.

8. The disperser according to claim 2, wherein the outer member and the inner member can be rotated relative to each other to selectively place the disperser in any one of the following states without disassembling the outer member and the inner member:
a contact state in which the tapered inner circumferential surface and the tapered outer circumferential surface are in contact with each other,
a use state in which the disperser is used and the clearance distance is small, and
a separate state in which the clearance distance is larger than in the use state.

9. The disperser according to claim 1, wherein an inner circumferential surface of the outer member and an outer circumferential surface of the inner member that define the flow path have no horizontal portion where the fluid flowing through the flow path may accumulate.

10. The disperser according to claim 1, wherein an inner circumferential surface of the outer member and an outer circumferential surface of the inner member that define the flow path are covered with a coating made of a corrosion-resistant material.

11. The disperser according to claim 10, wherein the coating is a fluoropolymer coating.

12. The disperser according to claim 1, wherein at least one of the outer member and the inner member has a jacket through which another fluid can flow to adjust temperature of the fluid flowing through the flow path.

13. A method for using the disperser of claim 8, comprising adjusting the clearance distance, wherein the adjusting includes:
rotating the outer member and the inner member relative to each other such that the inner member moves toward the other side with respect to the outer member to bring the disperser into the contact state; and
thereafter rotating the outer member and the inner member relative to each other such that the inner member moves toward the one side with respect to the outer member to bring the disperser into the use state.

14. The method according to claim 13, wherein the disperser is placed in the separate state where the outer member and the inner member are separated during cleaning or sterilization of the flow path.
